(19) United States
(12) Patent Application Publication
(10) Pub. No.: US 2025/0005395 A1
(43) Pub. Date: Jan. 2, 2025

(54) SYSTEM AND METHOD FOR OPERATING A DATA PIPELINE BASED ON DATA UNAVAILABILITY

(71) Applicant: Dell Products L.P., Round Rock, TX (US)

(72) Inventors: OFIR EZRIELEV, Beer Sheva (IL); HANNA YEHUDA, Acton, MA (US); INGA SOGAARD, Wichita, KS (US)

(21) Appl. No.: 18/343,959

(22) Filed: Jun. 29, 2023

(51) Int. Cl. G06N 5/04

(52) U.S. Cl. CPC G06N 5/04

(57) ABSTRACT

Methods and systems for managing operation of a data pipeline are disclosed. To manage operation of a data pipeline when data is unavailable may require imputing the unavailable data. The imputation of unavailable data may be analyzed to determine a likelihood that the imputed unavailable data may successfully predict the unavailable data. When the imputed data is determined to meet or exceed an uncertainty criteria, the imputed data may be utilized by the data pipeline while the data is unavailable.

### FIELD

Embodiments disclosed herein relate generally to data management. More particularly, embodiments disclosed herein relate to systems and methods to manage data using a data pipeline.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a data flow diagram illustrating a process of remediating data unavailability in accordance with an embodiment.

FIG. 2B shows a data flow diagram illustrating a process of operating a data pipeline in which data unavailability does not occur by the system of FIG. 1 in accordance with an embodiment.

FIG. 2C shows a data flow diagram illustrating a process of generating synthetic data when data unavailability occurs by the system of FIG. 1 in accordance with an embodiment.

FIG. 3 shows a data flow diagram illustrating a process of providing previously unavailable data in accordance with an embodiment.

FIG. 4 shows a flow diagram illustrating methods of managing operation of a data pipeline in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data pipeline. A data pipeline may ingest raw data (e.g., unstructured data), transform the raw data into usable formats (e.g., as required by a destination data repository of the data pipeline), and store data (e.g., within a data repository) for use by downstream consumers. For example, downstream consumers may rely on the stored data to be accessible in order to provide computer-implemented services.

Managing operation of a data pipeline may include obtaining a request for data and/or determining the availability of the data. The data may be unavailable, for instance, if the data is not stored available via a data manager (e.g., not stored in a data repository managed by the data manager, etc.) or if the data is not obtainable from a data source. Data unavailability in a data pipeline may interrupt and/or hinder the performance of the data pipeline (e.g., via misalignment of application programming interfaces (APIs)) and, thereby, obstruct a downstream consumer to provide computer-implemented services based on the data.

The data pipeline may utilize one or more data processing systems to manage the operation of the data pipeline, which may include synthetic data generation when the data is determined to be unavailable. Synthetic data generation may include using a trained inference model to generate synthetic data (e.g., prediction of the unavailable data) for which may be implemented in the data pipeline when the requested data is unavailable. For example, synthetic data generation may be implemented in order to provide synthetic data to a consumer when the requested data is unavailable. By doing so, embodiments disclosed herein may provide a system for generating synthetic data when the data requested is unavailable. The generation of synthetic data may reduce failures of the data pipeline (e.g., due to the inability to provide requested data) as a result of unavailable data in the data pipeline.

However, the synthetic data generated by an inference model may only be useful to a consumer if the synthetic data is reliable. To increase the likelihood that the synthetic data will be reliable (e.g., successfully predict the unavailable data) for use by a consumer, the system may obtain uncertainty quantifications for the synthetic data prior to providing the synthetic data to the consumer. Uncertainty quantifications may indicate a likelihood that the synthetic data (e.g., the inference) may successfully predict the data. A level of uncertainty of the synthetic data (e.g., the uncertainty quantification) may be compared to a minimum acceptable level of certainty (e.g., criteria as defined by the consumer) for the synthetic data. If the uncertainty quantification does not meet the criteria, the system may issue a denial of the data availability (e.g., the synthetic data may not be provided). If the uncertainty quantification does meet the criteria, the system may initiate a process of providing the synthetic data to the consumer. By doing so, reliability of the synthetic data may be increased while reducing failures of the data pipeline as a result of data unavailability.

In an embodiment, a method for managing operation of a data pipeline is provided. The method may include obtaining a request for data managed by the data pipeline; making a first determination regarding whether the data is available in via a data manager; in a first instance of the first determination where the data is not available via the data manager: obtaining an inference for the data; obtaining an uncertainty quantification for the inference; making a second determination regarding whether the uncertainty quantification meets a criteria; and in a first instance of the second determination where the uncertainty quantification meets the criteria: providing the inference to a requestor to service the request for the data.

Obtaining the request may include receiving a message from a downstream consumer, the message indicating the request, wherein the downstream consumer uses data sourced from one or more data sources of the data pipeline, wherein the request indicating a time sensitive need for the data by the downstream consumer, wherein the one or more data sources being operably connected via a communication channel to the data manager.

The communication channel may be subject to periods of temporary inoperability, and the communication channel supporting operation of an application programming interface through which the data manager is at least in part populated.

Making the first determination may include performing a look up for the data, the look up returning the data when the data is available via the data manager, and the look up returning an indication that the data is not available via the data manager when the data is not available via the data manager.

When the data is not available via the data manager, a disruption to the communication channel may have occurred or an incapability between the application programming interface and another entity may have arisen.

Obtaining the inference may include generating, using an inference model trained to predict the data based on another parameter, the inference.

The parameter may be one selected from a list of parameters consisting of: a point in time, and a portion of other data stored by the data manager.

The inference model may be based on historic data from the data pipeline, the historic data defining a relationship between the data and the other parameter.

Obtaining the uncertainty quantification may include generating the uncertainty quantification using the inference model, the uncertainty quantification indicating a likelihood that the inference successfully predicts the data.

Making the second determination regarding whether the uncertainty quantification meets the criteria may include making a comparison between the uncertainty quantification and the criteria, the criteria being a minimum acceptable level of certainty for the inference, wherein the criteria may be defined by the requestor.

The method may also include in a second instance of the second determination where the uncertainty quantification does not meet the criteria: issuing a denial for availability to the data to the requestor to service the request, the denial indicting the data responsive to the request is not available.

The method may also include in a second instance of the first determination where the data may be available via the data manager: providing the data to the requestor to service the request.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer-instructions are executed by the processor.

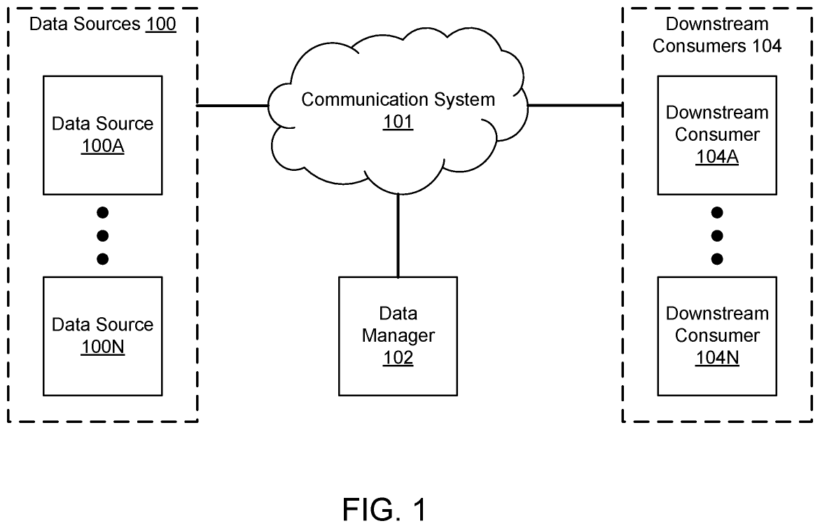

Turning to FIG. 1, a block diagram illustrating a system in accordance with an embodiment is shown. The system shown in FIG. 1 may provide computer-implemented services utilizing data obtained from any number of data sources and managed by a data manager prior to performing the computer-implemented services. The computer-implemented services may include any type and quantity of computer-implemented services. For example, the computer-implemented services may include monitoring services (e.g., of locations), communication services, and/or any other type of computer-implemented services.

To facilitate the computer-implemented services, the system may include data sources 100. Data sources 100 may include any number of data sources. For example, data sources 100 may include one data source (e.g., data source 100A) or multiple data sources (e.g., 100A-100N). Each data source of data sources 100 may include hardware and/or software components configured to obtain data, store data, provide data to other entities, and/or to perform any other task to facilitate performance of the computer-implemented services.

All, or a portion, of data sources 100 may provide (and/or participate in and/or support the) computer-implemented services to various computing devices operably connected to data sources 100. Different data sources may provide similar and/or different computer-implemented services.

For example, data sources 100 may include any number of temperature sensors positioned in an environment to collect temperature measurements according to a data collection schedule. Data sources 100 may be associated with a data pipeline and, therefore, may collect the temperature measurements, may perform processes to sort, organize, format, and/or otherwise prepare the data for future processing in the data pipeline, and/or may provide the data to other data processing systems in the data pipeline (e.g., via one or more application programming interfaces (APIs)).

Data sources 100 may provide data to data manager 102. Data manager 102 may include any number of data processing systems including hardware and/or software components configured to facilitate performance of the computer-implemented services. Data manager 102 may include a database (e.g., a data lake, a data warehouse, etc.) to store data obtained from data sources 100 (and/or other entities throughout a distributed environment).

Data manager 102 may obtain data (e.g., from data sources 100), process the data (e.g., clean the data, transform the data, extract values from the data, etc.), store the data, and/or may provide the data to other entities (e.g., downstream consumer 104) as part of facilitating the computer-implemented services.

Continuing with the above example, data manager 102 may obtain the temperature measurements from data sources 100 as part of the data pipeline. Data manager 102 may obtain the temperature measurements via a request through an API and/or via other methods. Data manager 102 may curate the temperature data (e.g., identify errors/omissions and correct them, etc.) and may store the curated temperature data temporarily and/or permanently in a data lake or other storage architecture. Following curating the temperature data, data manager 102 may provide the temperature measurements to other entities for use in performing the computer-implemented services.

Data managed by data manager 102 (e.g., stored in a data repository managed by data manager 102, obtained directly from internet of things (IoT) devices managed by data manager 102, etc.) may be provided to downstream consumers 104. Downstream consumers 104 may utilize the data from data sources 100 and/or data manager 102 to provide all, or a portion of, the computer-implemented services. For example, downstream consumers 104 may provide computer-implemented services to users of downstream consumers 104 and/or other computing devices operably connected to downstream consumers 104.

Downstream consumers 104 may include any number of downstream consumers (e.g., 104A-104N). For example, downstream consumers 104 may include one downstream consumer (e.g., 104A) or multiple downstream consumers (e.g., 104A-104N) that may individually and/or cooperatively provide the computer-implemented services.

All, or a portion, of downstream consumers 104 may provide (and/or participate in and/or support the) computer-implemented services to various computing devices operably connected to downstream consumers 104. Different downstream consumers may provide similar and/or different computer-implemented services.

Continuing with the above example, downstream consumers 104 may utilize the temperature data from data manager 102 as input data for climate models. Specifically, downstream consumers 104 may utilize the temperature data to simulate future temperature conditions in various environments over time (e.g., to predict weather patterns, climate change, etc.).

However, the ability of downstream consumers 104 to provide (and/or participate in and/or support the) computer-implemented services may depend on the availability of the data (e.g., access to the data). In some instances, the data may become unavailable (e.g., not accessible) to downstream consumers 104 based on a break in communication (e.g., due to misalignment of an API), for example, between data sources 100 and data manager 102 resulting in a lack of expected data available via data manager 102.

For example, the data requested by downstream consumers 104 may not be available via data manager 102 at the time the request is received by data manager 102 (e.g., due to, for example, misalignment of one or more APIs used by the data pipeline). As such, data manager 102 may provide a request to obtain the data (e.g., at any time prior to the request and/or in response to the request via an API) to data sources 100. Data sources 100 may be unable to service the request for data (e.g., provide the data to data manager 102) due to issues related to data sources 100 performance (e.g., inability to collect, store, and/or any other task that enables data source 100 to provide the data to data manager 102), communication break down between data sources 100 and data manager 102, and/or any other issues that may impede the ability to provide the data to data manager 102. If data sources 100 are unable to provide the requested data to data manager 102, data manager 102 may not be able to provide the requested data to the requestor (e.g., downstream consumers 104) resulting in a misalignment of the data pipeline and, therefore, an unexpected interruption to the computer-implemented services provided based on the data.

In general, embodiments disclosed herein may provide methods, systems, and/or devices for remediating misalignment of the data pipeline due to unavailability of data used to provide computer-implemented services. To do so, the system of FIG. 1 may generate synthetic data (e.g., non-real data) based on the requested data and provide the synthetic data to other data processing systems associated with the data pipeline (e.g., downstream consumers 104 and/or other entities) to facilitate the utilization of data for the computer-implemented services.

Additionally, the ability of downstream consumers 104 to provide accurate computer-implemented services using the synthetic data may depend on the reliability and/or other characteristics of the synthetic data. If the synthetic data provided to downstream consumer 104 is not reliable, then downstream consumers 104 may generate inaccurate predictions leading to unsuccessful or unhelpful computer-implemented services.

To determine reliability of the synthetic data, uncertainty quantifications for the synthetic data may be compared to criteria that provides a minimum acceptable level of certainty for the synthetic data based on previously recorded data (e.g., historical data). The criteria may include any number of levels, other parameters, etc. that may quantify a minimum standard of certainty. Synthetic data that does not meet the criteria may not be provided to downstream consumers 104 (and/or other requesting entities). By doing so, the likelihood that unreliable or inaccurate synthetic data may be provided to the requesting entities (e.g., downstream consumers 104) may be reduced. As such, downstream consumers 104 may be more likely to provide accurate computer-implemented services while the data is unavailable from data sources 100, for example.

To perform the above noted functionality, the system of FIG. 1 may: (i) obtain a request for data managed by the data pipeline, and/or (ii) determine whether the data is available via a data manager. If the data is not available via the data manager, the system of FIG. 1 may: (i) obtain an inference for the data, (ii) obtain an uncertainty quantification for the inference, and/or (iii) determine whether the uncertainty quantification meets a criterion If the uncertainty quantification meets the criterion the system of FIG. 1 may provide the inference to a requestor to service the request for the data.

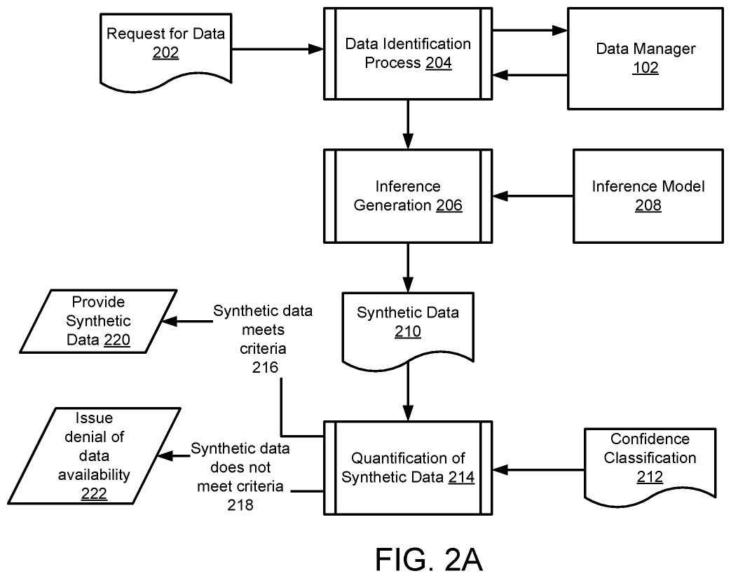

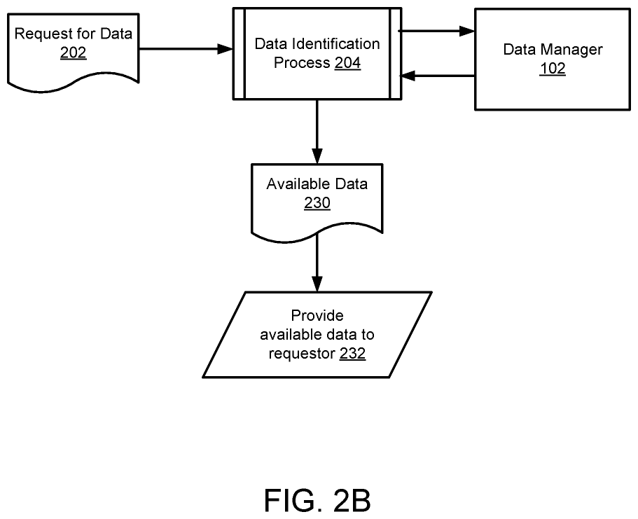

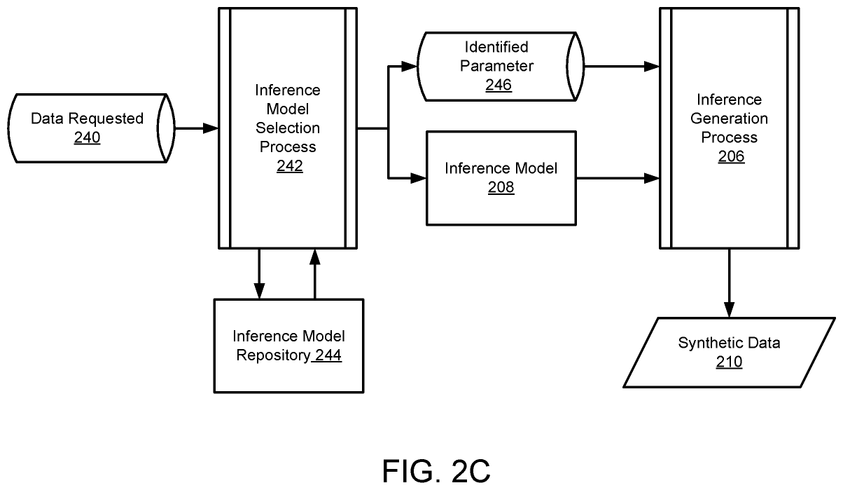

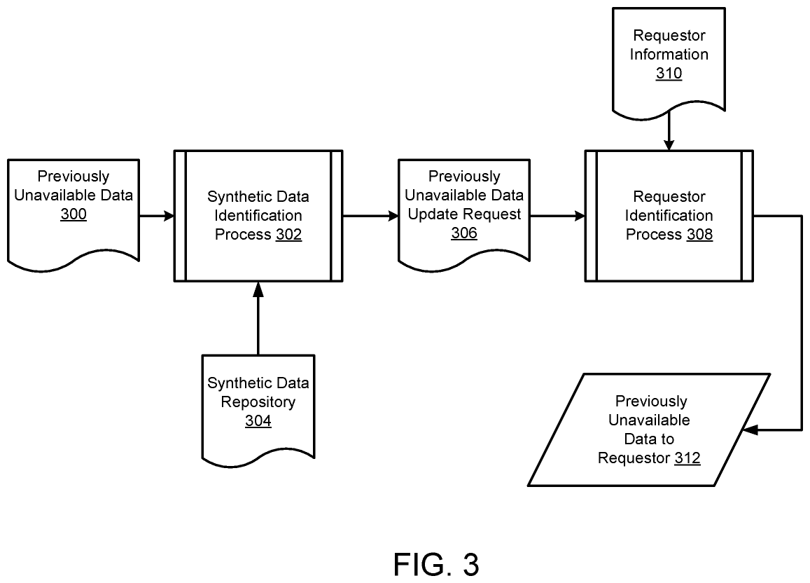

When performing its functionality, data sources 100, data manager 102, and/or downstream consumers 104 may perform all, or a portion, of the methods and/or actions shown in FIGS. 2A-2C, and 3.

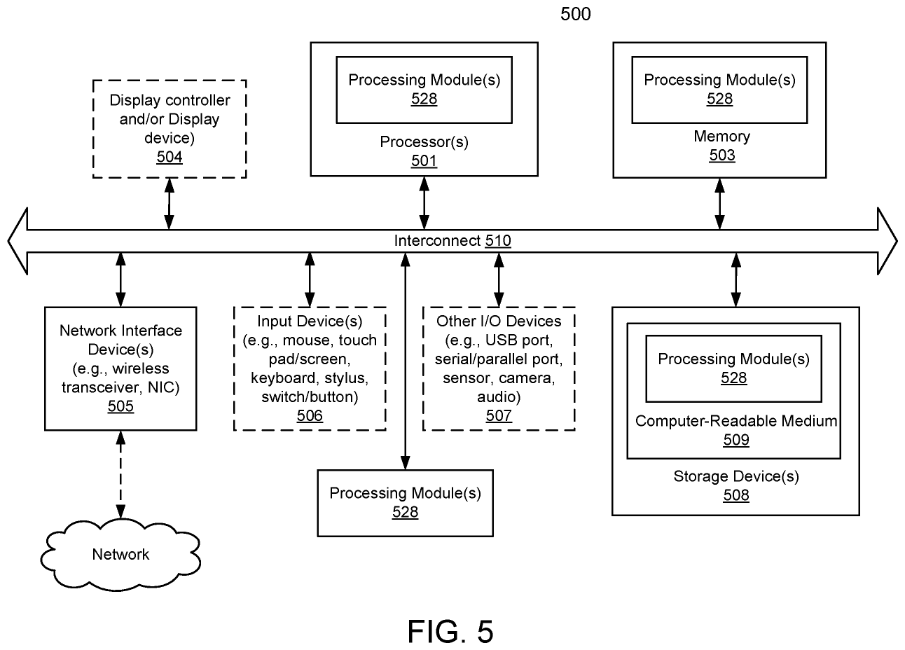

Data sources 100, data manager 102, and/or downstream consumers 104 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, one or more of data sources 100, data manager 102, and/or downstream consumers 104 are implemented using an internet of things (IoT) device, which may include a computing device. The IoT device may operate in accordance with a communication model and/or management model known to data sources 100, data manager 102, downstream consumers 104, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows implemented by a system over time in accordance with an embodiment are shown in FIGS. 2A-2C, and 3.

Turning to FIG. 2A, a first data flow diagram illustrating data flows during remediation of data unavailability by the system of FIG. 1 in accordance with an embodiment is shown.

As discussed above, one or more data sources 100, data manager 102, and/or downstream consumers 104 (shown in FIG. 1) may form (fully or in part) a data pipeline in which data may be collected, processed, stored, shared and/or otherwise prepared for providing to other data processing systems to service a request for the data. In some instances, the data may be unavailable due to a break in communication between one of the data processing systems of the data pipeline.

In order to manage operation of a data pipeline, the system may obtain request for data 202 from downstream consumer 104 and/or any other requesting entity. Request for data 202 may include an identifier for data in which the requesting entity (e.g., downstream consumer 104) is interested. In addition, request for data 202 may include an identifier associated with the requestor (e.g., downstream consumer 104) thereby identifying the individual, entity and/or data processing system (e.g., inference model associated with the data pipeline) requesting the data.

After request for data 202 is obtained, data identification process 204 may be initiated. Data identification process 204 may include identifying, based on request for data 202, data responsive to the request and/or any other identification of data responsive to the data request. Data identification process 204 may include performing a look up process using the type of requested data (e.g., an identifier for the requested data) to identify if the requested data is available via data manager 102. During data identification process 204, data as specified by the data request (e.g., request for data 202) may not be identified as available via data manager 102.

In order to facilitate continued performance of computer-implemented services when requested data is unavailable, the system may perform inference generation process 206 to generate inferences (e.g., predicted data based on the requested data). During inference generation process 206, inference model 208 may be obtained. Inferences (e.g., synthetic data) may be obtained using inference model 208. Inference model 208 may be any type of inference model (e.g., a neural network inference model) and may be trained to generate inferences (e.g., as part of inference generation process 206) indicating predicted data when the requested data is unavailable (e.g., data is not available via data manager 102). Refer to FIG. 2C for additional details regarding selecting an inference model.

Synthetic data 210 may be obtained by inference model 208 ingesting an identifier (e.g., a known parameter associated with the requested data) of the request for data 202. Synthetic data 210 may indicate a predicted data set and/or an uncertainty quantification (e.g., any information regarding the certainty level in which the data successfully predicts the unavailable data). For example, inference model 208 may ingest a timestamp and/or period of time (e.g., the identifier) associated with a temperature measurement (e.g., the requested data) from the request for data 202.

In addition, during the inference generation process 206, inference model 208 may generate an uncertainty level associated with synthetic data 210 (e.g., uncertainty quantification). For example, synthetic data 210 may include a prediction of the unavailable data and a likelihood that the data may successfully predict the unavailable data (e.g., uncertainty level).

To identify if synthetic data 210 should be provided to the requestor (e.g., when the requested data is unavailable), synthetic data 210 and confidence classification 212 may be used in quantification of synthetic data process 214. Confidence classification 212 may indicate a minimum acceptable level of certainty for the inference in order for the requestor to rely on the inference to make decisions and/or provide computer-implemented services. Quantification of synthetic data 214 process may include comparing synthetic data 210 (e.g., including the uncertainty quantification associated with synthetic data 210) to confidence classification 212 to determine whether the inference (e.g., synthetic data 210) should be provided to the requestor (e.g., downstream consumers 104).

For example, quantification of synthetic data 214 process may be performed by comparing synthetic data 210 to confidence classification 212. If the comparison indicates the inference does not at least meet the minimum level of certainty (e.g., synthetic data does not meet criteria 218 decision), then the data flow may proceed to issue denial of data availability 222 action. Issue denial of data availability 222 action may include providing a message (e.g., via a wireless communication system) to the requestor (e.g., downstream consumers 104) indicating the requested data is not available.

In contrast, if the comparison indicates the inference does meet or exceed the minimum level of certainty (e.g., synthetic data meets criteria 216 decision), then the data flow may proceed to provide synthetic data 220 action. Provide synthetic data 220 action may include providing synthetic data 210 to the requestor (e.g., downstream consumers 104) via wireless communication system, for example.

In addition, providing synthetic data 220 action may include: (i) inputting synthetic data 210 into the data pipeline, (ii) obtaining an output (e.g., generated by an inference model associated with the data pipeline) based on synthetic data 210, (iii) providing the output to the requestor (e.g., downstream consumer 104) via wireless communication system, and/or any other methods. For example, synthetic data 210 may be used as input for an artificial intelligence (AI) model used by the data pipeline and output from the artificial intelligence (AI) model (e.g., result from AI operation based on the input) may be provided to the requestor (e.g., downstream consumers 104).

Turning to FIG. 2B, a second data flow diagram illustrating data flows during operation of a data pipeline in which data unavailability does not occur by the system of FIG. 1 in accordance with an embodiment is shown. As discussed above, components of FIG. 1 (e.g., data sources 100, data manager 102, downstream consumers 104, and/or any other devices providing computer-implemented services) may be operably connected to each other in order to facilitate performance of the computer-implemented services (e.g., monitoring services, communication services, etc.).

With reference to FIG. 2B, request for data 202, data identification process 204, and data manager 102 may all perform similar methods as described above with respect to FIG. 2A. As previously described, data identification process 204 may include performing a look up process using an identifier for the data requested. During data identification process 204, data as specified by request for data 202 may be identified using a data repository (not shown) managed by data manager 102. For example, during the data identification process 204, the system may utilize the requested data from request for data 202 to identify a parameter associated with the requested data. Continuing the above-described example, a request for data may include a request for temperature measurements (e.g., requested data) for a specific time period and specific geographic region (e.g., known parameters associated with the requested data). Data manager 102 may use the requested time period and geographic region in order to perform a look up for temperature measurements in the data repository (and/or other data storage architecture) managed by data manager 102.

If the data (as specified by request for data 202) is available via data manager 102, then available data 230 may be generated by data identification process 204. Available data 230 may include identified data responsive to the request as indicated by request for data 202.

When available data 230 is obtained by the system, then the system may proceed to provide available data to requestor 232 (e.g., downstream consumer 104) action. Provide available data to requestor 232 action may include providing the data responsive to the request, and/or providing access to any other information regarding the data responsive to the request. The requestor (e.g., downstream consumers 104) may ingest the available data (e.g., via an API) via data manager 102, for example.

Once obtained, downstream consumer 104 (and/or any other requestor) may utilize available data responsive to the request for performing computer-implemented services (not shown). Continuing the above example, downstream consumers 104 may utilize temperature measurements (e.g., available data 230) from data manager 102 as input data for climate models.

Turning to FIG. 2C, a third data flow diagram illustrating data flows during generation of synthetic data when data unavailability occurs by the system of FIG. 1 in accordance with an embodiment is shown.

As discussed previously in FIG. 2A, an inference model may be utilized to generate one or more inferences (e.g., synthetic data 210) when the data responsive to the request is not available via data manager 102. For example, during data identification process 204, data responsive to the data request (e.g., request for data 202 shown in FIG. 2A) may not be available via data manager 102.

Continuing with the discussion from FIG. 2A, if the data requested (as specified by request for data 202 shown in FIG. 2A) is not identified as available via data manager 102 during data identification process 204 (e.g., the data is not stored in a data repository managed by data manager 102, etc.), inference generation process 206 may be initiated. To initiate inference generation process 206, data requested 240 may be used for inference model selection process 242. Data requested 240 may include identifiers for the requested data and/or other information associated with the requested data (e.g., other known parameters such as a period of time and/or other portion of data available via data manager 102). For example, data requested 240 may include a request for temperature measurements collected by a data collector during a specific period of time.

Inference model selection process 242 may analyze data requested 240 (e.g., identifiers for the data) to determine which inference model should be selected to generate the inference (e.g., synthetic data 210). Inference model selection process 242 may include performing a look up using inference model repository 244 to identify an inference model capable of generating an inference based on the specific type of data requested.

Inference model repository 244 may store any number of inference models (e.g., including inference model 208). Each of the inference models stored in inference model repository 244 may be trained to generate inferences predicting a portion of data based on another known parameter (e.g., such as period of time). Inference model selection process 242 may include determining that inference model 208 is usable based on data requested 240.

Continuing the above example, inference model 208 may be trained to predict temperature measurements for a specific location during a period of time based on historic data (e.g., previously recorded data) obtained through the data pipeline (e.g., via data sources 100).

Once inference model 208 is obtained from inference model repository 244, inference model selection process 242 may also include obtaining identified parameter 246 from data requested 240. Identified parameter 246 may include a parameter associated with the predicted data (e.g., a period of time). In order to generate the inference (e.g., synthetic data 210), inference generation process 206 may utilize inference model 208 (and/or any other inference model selected by inference model selection process 242) and identified parameter 246. During inference generation process 206, identified parameter 246 may be fed into inference model 208 in order to obtain an inference model result (e.g., synthetic data 210).

Synthetic data 210 may be transmitted (e.g., via a wireless communication system) to the requestor (e.g., downstream consumers 104 and/or another data processing system). Synthetic data 210 may be utilized by downstream consumers 104 of the data in order to perform a task, make a decision, and/or perform any other action that may rely on the inference generated by the inference model. For example, synthetic data 210 may include predicted weather temperature data for a specific geographic region useable by downstream consumers 104 to provide weather forecasting services.

In addition, synthetic data 210 may be provided to another data processing system in the data pipeline for additional processing or further computation. For example, synthetic data 210 may be used as input to train (and/or re-train) an inference model to perform computer-implemented services as specified by the inference model. For instance, an inference model may be trained using synthetic data 210 (e.g., inputting predicted weather temperature data) to predict weather forecasting services for a specific geographic region.

Turning to FIG. 3, a fourth data flow diagram illustrating data flow during operations for providing a requestor with previously unavailable data by the system of FIG. 1 in accordance with an embodiment is shown. As discussed with respect to FIGS. 2A and 2C, the system may provide predicted data (e.g., synthetic data 210) to the requestors (e.g., downstream consumers 104 and/or to another data processing system in the data pipeline for additional processing (e.g., input for an inference model) when the requested data (e.g., as specified by request for data 202) is not available. Now, consider an example scenario in accordance with an embodiment in which previously unavailable data becomes available after the requestor has been provided predicted data (e.g., synthetic data 210).

For example, data manager 102 may receive an indication that requested data that was previously unavailable (e.g., not obtainable from data sources 100) has become available. In these instances, previously unavailable data 300 may be obtained from data sources 100 (and/or any other data sources). Previously unavailable data 300 may include the data responsive to one or more previous requests (e.g., from downstream consumers 104).

Once obtained, the system may perform synthetic data identification process 302 through which previously unavailable data 300 is analyzed and used to obtain previously unavailable data update request 306. During synthetic data identification process 302, synthetic data repository 304 may be parsed or otherwise processed to identify the synthetic data provided to the requestor (e.g., by using the type or an identifier of previously unavailable data 300 as a key to perform a lookup). For example, synthetic data identification process 302 may utilize previously unavailable data 300 (e.g., an identifier associated with the data) to identify if synthetic data was provided to the requestor and the portion of synthetic data that was provided to the requestor.

Synthetic data repository 304 may include a database (e.g., a data warehouse, a data lake, etc.) to store synthetic data (e.g., inferences) obtained through inference generation process (e.g., inference generation process 206) and approved to provide to the requestor (e.g., downstream consumer 104) through quantification of synthetic data process 214 (e.g., synthetic data meets criteria 216 decision).

Continuing with the previous example, a downstream consumer may have previously requested a temperature measurement at a particular time for use in simulating future weather patterns. The requested temperature measurement may have previously been unavailable (e.g., via misalignment of one or more APIs used by the data pipeline, etc.) and an inference (e.g., a synthetic temperature measurement) may have been provided to the downstream consumer. However, communications may have resumed between one or more data sources and other portions of the data pipeline and, as a result, the previously requested temperature measurement may become available.

Previously unavailable data update request 306 may include a request to provide previously unavailable data 300 to the requestor (e.g., downstream consumers 104). Previously unavailable data update request 306 may indicate that the synthetic data previously provided to the requestor (e.g., individual or entity that provided the original request for data) is to be updated using the available data (e.g., previously unavailable data 300).

Once generated, previously unavailable data update request 306 may drive requestor identification process 308. During requestor identification process 308, requestor information 310 may be parsed or otherwise processed to identify the individual or entity that should be provided the previously unavailable data. Requestor information 310 may include a repository (e.g., database, data warehouse, etc.) to store the identification (e.g., an identifier and/or metadata) of the requestor (e.g., downstream consumers 104) and/or any information necessary to facilitate the communication to the requestor with the previously unavailable data.

When requestor information associated with the requesting entity (e.g., obtained from requestor information 310) has been identified, requestor identification process 308 may utilize the requestor information and previously unavailable data 300 (e.g., obtained by previously unavailable data update request 306) to provide the requestor with previously unavailable data 300 via previously unavailable data to requestor 312 action. For example, the system may send a message to the requestor (via wireless communication) that the data previously requested has become available and the message may contain the newly available data (e.g., previously unavailable data 300).

Once obtained by downstream consumers 104, previously unavailable data 300 may be utilized to perform the desired computer-implemented services and/or update the previous uses of synthetic data 210 received in place of the unavailable data at the time of the request. For example, downstream consumers 104 may have previously utilized synthetic data 210 to predict future climate forecasts (e.g., weather temperature, climate change, etc.). Once downstream consumers 104 obtain previously unavailable data 300 (e.g., live weather data), downstream consumers 104 may reconfigure the previously calculated climate forecast to include the live weather data to more accurately perform weather predictions in the future.

In an embodiment, the one or more entities performing the operations shown in FIG. 2A-3 are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

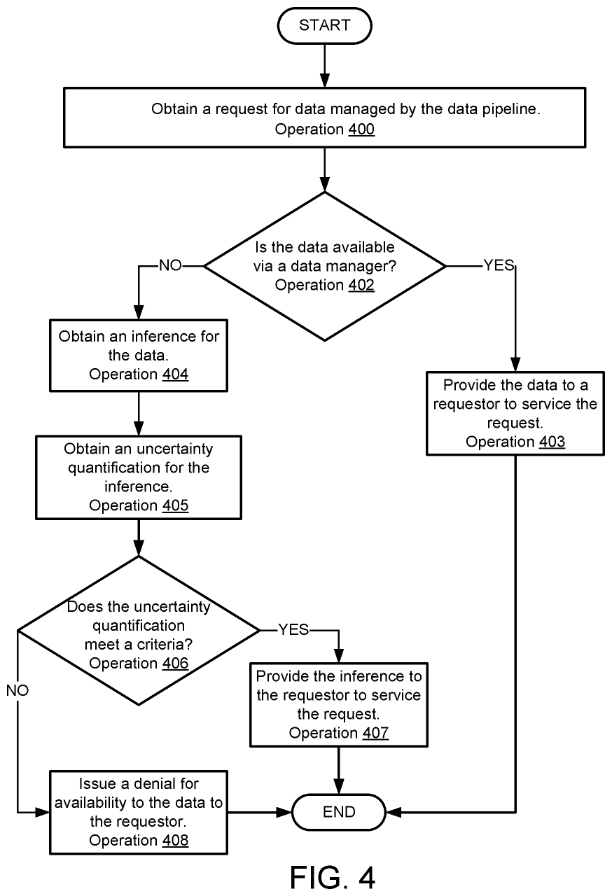

As discussed above, the components of FIG. 1 may perform various methods to manage operation of a data pipeline. FIG. 4 illustrates methods that may be performed by the components of the system of FIG. 1. In the diagram discussed below and shown in FIG. 4, any of the operations may be repeated, performed in different orders, and/or performed in parallel with or in a partially overlapping in time manner with other operations.

Turning to FIG. 4, a flow diagram illustrating a method for managing operation of a data pipeline in accordance with an embodiment is shown. The method may be performed by any of data sources 100, data manager 102, downstream consumers 104, and/or other entities without departing from embodiments disclosed herein.

At operation 400, a request for data managed by the data pipeline is obtained. The request for the data may be obtained by (i) receiving the request via a communication, (ii) by reading the request from storage, and/or any other method. For example, a data manager may receive a message (via a communication channel) from a downstream consumer indicating a time sensitive need for the data by the downstream consumer.

At operation 402, it is determined whether the data is available via a data manager. The determination may be made by performing a look up process for the data in storage (e.g., a data repository, temporary and/or permanent storage for an IoT device associated with the data pipeline, etc.) managed by a data manager using an identifier associated with the data as a key for the look up process. The look up process may return the data when the data is available via the data manager and the look up process may return an indication that the data is not available via the data manager when the data is not available via the data manager. The indication that the data is not available via the data manager may also indicate an occurrence of a disruption to a communication channel and/or a misalignment of an API used by the data pipeline, for example.

Determining whether the data is available from the data manager may also be performed by transmitting an identifier for the requested data to another entity responsible for hosting the data manager and/or via other methods.

If the data is available via the data manager (e.g., the determination is “Yes” at operation 402), then the method may proceed to operation 403. At operation 403, the data to service the request is provided to the requestor. The data may be provided by sending the data to the requesting individual or entity via communication through an API, by providing the data to another entity and requesting the entity provide the data to the requesting individual or entity, and/or any other methods. The method may end following operation 403.

Returning to operation 402, if the data is not available via the data manager (e.g., the determination is “No” at operation 402), then the method may proceed to operation 404. At operation 404, an inference for the data is obtained. The inference may indicate a prediction of the data based on another parameter.

The inference for the data may be obtained by (i) receiving the inference from another device, (ii) reading the inference from storage, and/or (iii) via generation of the inference. The inference may be generated by (i) ingesting the request data into an inference model, and (ii) obtaining the inference as an output from the inference model based on a parameter associated with the data.

Generating an inference may include obtaining an inference model using a variety of processes such as through generation (e.g., training the inference model using training data), acquisition from an external entity, data imputation, and/or by any other method. The trained inference model may have been trained to generate inferences to predict data based on another parameter. The parameter may be selected from a list of parameters consisting of a point in time, a portion of other data managed by a data manager, etc. The inference model may be based on historic data from the data pipeline and defines a relationship between the data and the other parameter.

The inference generation process may also include selecting an inference model based on a parameter associated with the requested data. Selecting the inference model may include (i) identifying a known parameter associated with the requested data, (ii) performing a look up process using an inference model lookup table and the known parameter as a key for the inference model lookup table to identify an inference model trained to generate inferences for the type of requested data.

At operation 405, an uncertainty quantification for the inference may be obtained. The uncertainty quantification may be obtained by (i) generation using the inference model, (ii) receiving the uncertainty quantification from another device, (iii) reading the uncertainty quantification from storage, and/or any other method. The uncertainty quantification may indicate a likelihood that the inference (e.g., synthetic data) successfully predicts the data.

At operation 406, a determination is made regarding whether the uncertainty quantification meets criteria. The criteria may be defined by the requestor (e.g., the individual or entity requesting the data). The criteria may indicate a minimum acceptable level of certainty for the inference. For example, the requestor may designate a minimum percentage of certainty that the synthetic data must meet in order for the requestor to rely on the synthetic data.

The determination may be made by (i) making a comparison between the uncertainty quantification and the criteria, (ii) providing the uncertainty quantification to another data processing system to make the determination and/or any other method. Making the comparison between the uncertainty quantification may include (i) obtaining the uncertainty quantification, (ii) obtaining the criteria, and/or (iii) evaluating whether the uncertainty quantification meets and/or exceeds the criteria.

If the uncertainty quantification meets or exceeds the criteria (e.g., the determination is “Yes” at operation 306), then the method may proceed to operation 407. At operation 407, the inference to service the request may be provided to the requestor. The inference may be provided by (i) providing the inference to the requesting individual or entity via communication by a data processing system (e.g., in the form of a message, etc.), (ii) transmitting the inference to another entity responsible for providing the inference to the requesting individual or entity, (iii) by storing the inference in a database and notifying the requesting individual or entity that the inference is available in the database, (iv) providing the inference to another data processing system (e.g. inference model) and obtaining an output for the requestor based on the inference, and/or any other methods. The method may end following operation 407.

Returning to operation 406, if the uncertainty quantification does not meet the criteria (e.g., the determination is “No” at operation 406), then the method may proceed to operation 408. At operation 408, a denial for availability to the data may be issued to the requestor. The denial for availability to the data may be issued by (i) providing, via wireless communication, a message indicating the requested data is unavailable, (ii) not providing the inference (or other communication) to the requesting entity, and/or any other method. The denial for availability to the data may indicate the data responsive to the request is not available.

The method may end following operation 408.

Any of the components illustrated in FIGS. 1-4 may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data pipeline, the method comprising:
obtaining a request for data managed by the data pipeline;
making a first determination regarding whether the data is available via a data manager;
in a first instance of the first determination where the data is not available via the data manager:
obtaining an inference for the data;
obtaining an uncertainty quantification for the inference;
making a second determination regarding whether the uncertainty quantification meets a criteria; and
in a first instance of the second determination where the uncertainty quantification meets the criteria:
providing the inference to a requestor to service the request for the data.

2. The method of claim 1, wherein obtaining the request comprises:
receiving a message from a downstream consumer, the message indicating the request,
wherein the downstream consumer uses data sourced from one or more data sources of the data pipeline,
wherein the request indicating a time sensitive need for the data by the downstream consumer,
wherein the one or more data sources being operably connected via a communication channel to the data manager.

3. The method of claim 2, wherein the communication channel is subject to periods of temporary inoperability, and the communication channel supporting operation of an application programming interface through which the data manager is at least in part populated.

4. The method of claim 3, wherein making the first determination comprises:
performing a look up for the data, the look up returning the data when the data is available via the data manager, and the look up returning an indication that the data is not available via the data manager when the data is not available via the data manager.

5. The method of claim 4, wherein when the data is not available via the data manager, a disruption to the communication channel occurred or an incapability between the application programming interface and another entity has arisen.

6. The method of claim 1, wherein obtaining the inference comprises:
generating, using an inference model trained to predict the data based on another parameter, the inference.

7. The method of claim 6, wherein the parameter is one selected from a list of parameters consisting of: a point in time, and a portion of other data stored by the data manager.

8. The method of claim 7, wherein the inference model is based on historic data from the data pipeline, the historic data defining a relationship between the data and the other parameter.

9. The method of claim 8, wherein obtaining the uncertainty quantification comprises:
generating the uncertainty quantification using the inference model, the uncertainty quantification indicating a likelihood that the inference successfully predicts the data.

10. The method of claim 1, wherein making the second determination regarding whether the uncertainty quantification meets the criteria comprises:
making a comparison between the uncertainty quantification and the criteria, the criteria being a minimum acceptable level of certainty for the inference,
wherein the criteria being defined by the requestor.

11. The method of claim 1, further comprising:
in a second instance of the second determination where the uncertainty quantification does not meet the criteria:
issuing a denial for availability to the data to the requestor to service the request, the denial indicating the data responsive to the request is not available.

12. The method of claim 1, further comprising:
in a second instance of the first determination where the data is available via the data manager:
providing the data to the requestor to service the request.

13. A non-transitory machine-readable medium having instructions stored therein, which when executed by a processor, cause the processor to perform operations for managing operation of a data pipeline, the operations comprising:
obtaining a request for data managed by the data pipeline;
making a first determination regarding whether the data is available via a data manager;
in a first instance of the first determination where the data is not available via the data manager:
obtaining an inference for the data;
obtaining an uncertainty quantification for the inference;
making a second determination regarding whether the uncertainty quantification meets a criteria; and
in a first instance of the second determination where the uncertainty quantification meets the criteria:
providing the inference to a requestor to service the request for the data.

14. The non-transitory machine-readable medium of claim 13, wherein obtaining the request comprises:
receiving a message from a downstream consumer, the message indicating the request,
wherein the downstream consumer uses data sourced from one or more data sources of the data pipeline,
wherein the request indicating a time sensitive need for the data by the downstream consumer,
wherein the one or more data sources being operably connected via a communication channel to the data manager.

15. The non-transitory machine-readable medium of claim 14, wherein the communication channel is subject to periods of temporary inoperability, and the communication channel supporting operation of an application programming interface through which the data manager is at least in part populated.

16. The non-transitory machine-readable medium of claim 15, wherein making the first determination comprises:
performing a look up for the data, the look up returning the data when the data is available via the data manager, and the look up returning an indication that the data is not available via the data manager when the data is not available via the data manager.

17. A data processing system, comprising:
a processor; and
a memory coupled to the processor to store instructions, which when executed by the processor, cause the processor to perform operations for managing operation of a data pipeline, the operations comprising:
obtaining a request for data managed by the data pipeline;
making a first determination regarding whether the data is available via a data manager;
in a first instance of the first determination where the data is not available via the data manager:
obtaining an inference for the data;
obtaining an uncertainty quantification for the inference;
making a second determination regarding whether the uncertainty quantification meets a criteria; and
in a first instance of the second determination where the uncertainty quantification meets the criteria:
providing the inference to a requestor to service the request for the data.

18. The data processing system of claim 17, wherein obtaining the request comprises:
receiving a message from a downstream consumer, the message indicating the request,
wherein the downstream consumer uses data sourced from one or more data sources of the data pipeline,
wherein the request indicating a time sensitive need for the data by the downstream consumer,
wherein the one or more data sources being operably connected via a communication channel to the data manager.

19. The data processing system of claim 18, wherein the communication channel is subject to periods of temporary inoperability, and the communication channel supporting operation of an application programming interface through which the data manager is at least in part populated.

20. The data processing system of claim 19, wherein making the first determination comprises:
performing a look up for the data, the look up returning the data when the data is available via the data manager, and the look up returning an indication that the data is not available via the data manager when the data is not available via the data manager.
